(19) United States
(12) Patent Application Publication
(10) Pub. No.: US 2026/0264427 A1
(43) Pub. Date: Sep. 10, 2026

(54) INKJET PRINTER

(71) Applicant: BROTHER KOGYO KABUSHIKI KAISHA, Nagoya (JP)

(72) Inventor: Hiroshi TAIRA, Ichinomiya (JP)

(21) Appl. No.: 19/461,259

(22) Filed: Jan. 27, 2026

(30) Foreign Application Priority Data
Jan. 30, 2025 (JP) 2025-014149

(51) Int. Cl. B41J 19/04; B41J 25/00; B41J 29/02

(52) U.S. Cl. CPC B41J 19/04; B41J 25/001; B41J 29/02

(57) ABSTRACT

An inkjet printer includes: a first guide extending in a main scanning direction; a carriage on which a recording head configured to eject a liquid in an ejection direction intersecting the main scanning direction configured to be mounted, the carriage being configured to move along the first guide; and a first intermediate member configured to: support the carriage with respect to the first guide, and being rotatable about an axial center along at least one direction of the ejection direction, and a sub-scanning direction intersecting the main scanning direction and the ejection direction with respect to the carriage.

### REFERENCE TO RELATED APPLICATIONS

This application claims priority from Japanese Patent Application No. 2025-014149 filed on Jan. 30, 2025. The entire contents of the priority application are incorporated herein by reference.

### BACKGROUND ART

In a related art, an inkjet printer that forms an image on a recording medium by ejecting ink from a recording head is disclosed. The printer disclosed in the related art includes a carriage on which the recording head is mounted, and the carriage is slidably supported on a long guide member, and is able to run along the guide member. Specifically, the printer includes a shaft (2A) having a circular cross section as the guide member, a cylindrical sliding body (6) fitted onto the shaft, and a carriage body (7) attached to the sliding body.

However, the guide member (shaft) that supports the carriage is subject to an inertial force and a vibration as the carriage moves, and thus the guide member may be deformed such as being bent. When the guide member is deformed, for example, the contact between the sliding body and the guide member may change from surface contact to high-pressure point contact, which hinders smooth movement of the carriage, or a posture of the carriage may become unstable due to following the deformation of the guide member. In addition, such a situation causes a deviation of a stop position with respect to a printing position of the head or a deviation of a landing position of the ink to be ejected from the head, and deteriorates the image quality.

### SUMMARY

Therefore, an object of the present disclosure is to provide an inkjet printer capable of stabilizing a posture of a moving carriage or making the movement of the carriage smooth, thereby improving quality of a printed image.

An inkjet printer according to the present disclosure includes: a first guide extending in a main scanning direction; a carriage on which a recording head configured to eject a liquid in an ejection direction intersecting the main scanning direction configured to be mounted, and the carriage being configured to move along the first guide; and a first intermediate member configured to: support the carriage with respect to the first guide, and being rotatable about an axial center along at least one direction of the ejection direction, and a sub-scanning direction intersecting the main scanning direction and the ejection direction with respect to the carriage.

### BRIEF DESCRIPTION OF DRAWINGS

FIG. 1 is a diagram illustrating an inkjet printer according to an embodiment of the present disclosure.

FIG. 2 is a perspective view illustrating a head conveying device, in which a first guide holder is omitted.

FIG. 3 is a perspective view of a carriage on which two recording heads are mounted.

FIG. 4 is a perspective view illustrating the carriage in a state in which a right frame is removed.

FIG. 5 is an exploded perspective view illustrating a part of the carriage in a state in which the recording heads are removed.

FIG. 6A is a perspective view of a front beam and a rear beam, and FIG. 6B is a perspective view illustrating a state in which first intermediate members are partially accommodated in the front beam and a state in which second intermediate members are partially accommodated in the rear beam.

FIG. 7A is a perspective view illustrating left and right front opening portions and left and right first intermediate members separated from each other, and FIG. 7B is a perspective view illustrating a state in which the first intermediate members are fitted into the left and right front opening portions, respectively.

FIG. 8A is a perspective view illustrating left and right rear opening portions and left and right second intermediate members separated from each other, and FIG. 8B is a perspective view illustrating a state in which the second intermediate members are fitted into the left and right rear opening portions, respectively.

FIG. 9A is a schematic diagram of the periphery of the first intermediate member when viewed along an up-down direction, and FIG. 9B is a schematic diagram of the periphery of the first intermediate member when viewed along a front-rear direction.

### DESCRIPTION

Hereinafter, an embodiment according to the present disclosure will be described in detail with reference to the drawings. In the following description, the same or corresponding elements in all the drawings are denoted by the same reference signs, and redundant description thereof is omitted.

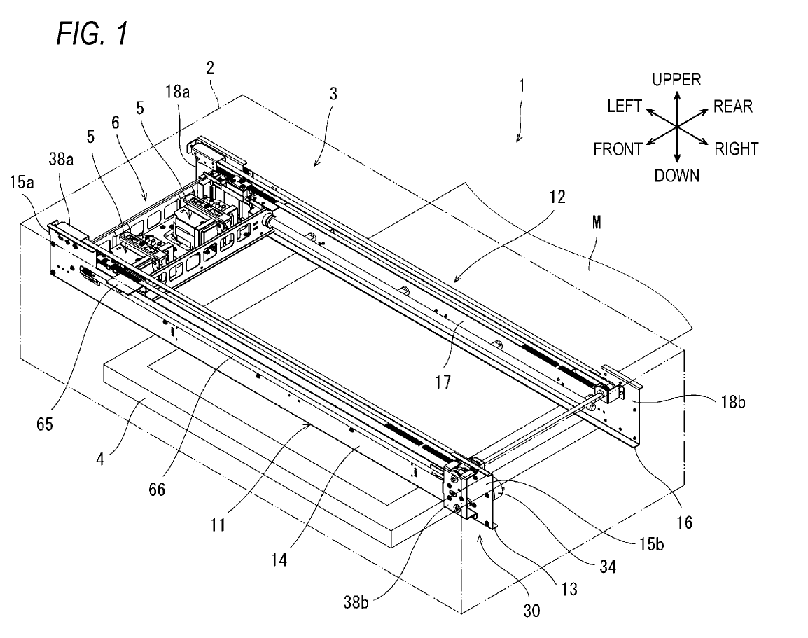

FIG. 1 is a diagram illustrating an inkjet printer 1 (hereinafter, also referred to as a "printer 1") according to an embodiment of the present disclosure. The printer 1 includes a head conveying device 3 and a platen 4 in a box-shaped housing 2, for example. The head conveying device 3 is a device that causes a carriage 6 on which a recording head 5 is mounted to move in a main scanning direction, and the platen 4 is disposed below the head conveying device 3. An image can be printed (recorded) on a recording medium M by ejecting a liquid such as ink from the recording head 5 onto the recording medium M placed on the platen 4.

The printer 1 is, for example, a garment printer that prints an image on clothes or the like, but a recording medium to be printed is not limited to clothes. For example, the printer 1 of the present disclosure can also be applied to a printer that prints an image on a recording medium such as cut paper or roll paper, or other printers. The platen 4 may be movable in a sub-scanning direction intersecting the main scanning direction together with the recording medium M placed thereon. Alternatively, the platen 4 may be fixed to the housing 2, and the printer 1 may separately include a conveying device that conveys the recording medium M in the sub-scanning direction.

Hereinafter, a configuration of the printer 1, in particular, a specific configuration of the head conveying device 3 will be described. Hereinafter, for convenience of description, the main scanning direction is also referred to as a left-right direction, and the sub-scanning direction is also referred to as a front-rear direction. A direction intersecting both the main scanning direction and the sub-scanning direction is an ejection direction in which a liquid is ejected from the recording head 5, and is also referred to as an up-down direction. The orientations of the upper, lower, left, right, front, and rear are as illustrated in FIG. 1.

### 1. Guide Holder

As illustrated in FIG. 1, the head conveying device 3 includes a first guide holder 11 and a second guide holder 12 extending in the left-right direction. The first guide holder 11 and the second guide holder 12 are arranged parallel to each other, spaced apart from each other in the front-rear direction, and are fixed to the housing 2.

The front first guide holder 11 has a configuration in which a lower portion of a metal plate long in the left-right direction is bent at a right angle along a line along a longitudinal direction, and includes a bottom plate portion 13 having a surface intersecting the up-down direction and a side plate portion 14 having a surface intersecting the front-rear direction. The bottom plate portion 13 is fixed to the housing 2. A left extension plate portion 15a extends upward from a left end portion of the side plate portion 14, and a right extension plate portion 15b extends upward from a right end portion of the side plate portion 14.

The rear second guide holder 12 has the same configuration as the first guide holder 11. That is, the second guide holder 12 has a configuration in which a lower portion of a metal plate long in the left-right direction is bent at a right angle along a line along the longitudinal direction, and includes a bottom plate portion 16 having a surface intersecting the up-down direction and a side plate portion 17 having a surface intersecting the front-rear direction. The bottom plate portion 16 is fixed to the housing 2. In addition, a left extension plate portion 18a extends upward from a left end portion of the side plate portion 17, and a right extension plate portion 18b extends upward from a right end portion of the side plate portion 17.

The bottom plate portion 13 of the first guide holder 11 extends rearward from a lower end of the side plate portion 14 toward the second guide holder 12, and the bottom plate portion 16 of the second guide holder 12 extends forward from a lower end of the side plate portion 17 toward the first guide holder 11. That is, the bottom plate portion 13 and the bottom plate portion 16 extend in a direction (inward) toward each other in a second direction.

### 2. Guide

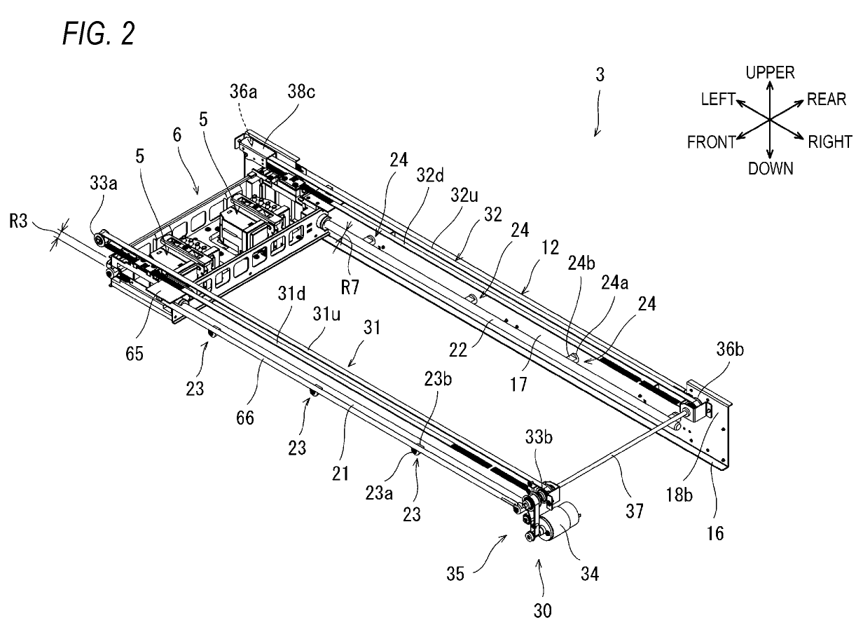

FIG. 2 is a perspective view illustrating the head conveying device 3, in which the first guide holder 11 is omitted. As illustrated in FIGS. 1 and 2, the head conveying device 3 includes a first guide 21 extending in the left-right direction and a second guide 22 extending in the left-right direction and separate from the first guide 21. The first guide 21 is fixed to and supported by the first guide holder 11, and the second guide 22 is fixed to and supported by the second guide holder 12.

The first guide 21 is constituted by a columnar member long in the left-right direction, and a length dimension of the first guide 21 is slightly smaller than a length dimension of the first guide holder 11. The first guide 21 is supported by a plurality of support protrusions 23 protruding rearward (inward) from the side plate portion 14 of the first guide holder 11. The plurality of support protrusions 23 are arranged at equal intervals along the left-right direction, and five support protrusions 23 are provided in the present embodiment. Each of the support protrusions 23 has a base end portion 23a connected to an inner surface (rear surface) of the side plate portion 14 and a leading end portion 23b connected to a side surface (front surface) of the first guide 21.

The support protrusion 23 is constituted by, for example, a columnar member having an axial center along the front-rear direction, and an upper portion, or the upper portion and a lower portion are cut out at the leading end portion 23b that is in the vicinity of a connection location with the first guide 21. Therefore, a thickness dimension of the leading end portion 23b in the up-down direction is smaller than a thickness dimension of the base end portion 23a in the up-down direction, and smaller than a thickness dimension of the first guide 21 in the up-down direction (that is, a diameter dimension of the first guide 21).

The configuration and support mode of the second guide 22 are also similar to those described above. That is, the second guide 22 is constituted by a columnar member long in the left-right direction, and a length dimension of the second guide 22 is slightly smaller than a length dimension of the second guide holder 12. The second guide 22 is supported by a plurality of support protrusions 24 protruding forward (inward) from the side plate portion 17 of the second guide holder 12. The plurality of support protrusions 24 are arranged at equal intervals along the left-right direction, and five support protrusions 24 are provided in the present embodiment. Each of the support protrusions 24 has a base end portion 24a connected to an inner surface (front surface) of the side plate portion 17 and a leading end portion 24b connected to a side surface (rear surface) of the second guide 22.

The support protrusion 24 is constituted by, for example, a columnar member having an axial center along the front-rear direction, and an upper portion, or the upper portion and a lower portion are cut out at the leading end portion 24b that is in the vicinity of a connection location with the second guide 22. Therefore, a thickness dimension of the leading end portion 24b in the up-down direction is smaller than a thickness dimension of the base end portion 24a in the up-down direction, and smaller than a thickness dimension of the second guide 22 in the up-down direction (that is, a diameter dimension of the second guide 22).

The first guide 21 and the second guide 22 have the same length dimension and the same diameter dimension. The first guide 21 and the second guide 22 are positioned horizontally and at the same height in a state in which the printer 1 is placed on a horizontal plane. The plurality of support protrusions 23 for the first guide 21 and the plurality of support protrusions 24 for the second guide 22 are provided at the same positions in the left-right direction. Therefore, the first guide 21 and the second guide 22 have substantially the same specifications in terms of resistance to a mechanical load (posture stability).

The columnar members constituting the first guide 21 and the second guide 22 are required to have high straightness. When there is a difference in straightness within the tolerance range, a columnar member having higher straightness (smaller error) is selected as the first guide 21.

### 3. Drive Mechanism

As illustrated in FIGS. 1 and 2, the head conveying device 3 includes a drive mechanism 30 that causes the carriage 6 on which the recording head 5 is mounted to move (scan) in the left-right direction. The drive mechanism 30 includes a first belt 31 provided on a front side and a second belt 32 provided on a rear side and spaced apart from the first belt 31 in the front-rear direction (sub-scanning direction).

The front first belt 31 is an endless belt having an annular shape and is wound between a left pulley 33a and a right pulley 33b. The left pulley 33a protrudes rearward with respect to the left extension plate portion 15a of the first guide holder 11, and a rotation axial center is oriented in the front-rear direction. The right pulley 33b protrudes rearward with respect to the right extension plate portion 15b of the first guide holder 11, and a rotation axial center is oriented in the front-rear direction.

The first belt 31 wound between the left pulley 33a and the right pulley 33b includes a belt upper portion 31u that travels in one direction of the left-right direction and a belt lower portion 31d that travels in a direction opposite to the belt upper portion 31u. The first belt 31 is located above the first guide 21, and at least the belt lower portion 31d is parallel to the first guide 21. The right pulley 33b is attached so as to be fixed in a position with respect to the right extension plate portion 15b, while the left pulley 33a is a tension pulley and can change a position in the left-right direction with respect to the left extension plate portion 15a. Accordingly, an appropriate tension can be applied to the first belt 31.

A drive motor 34 is provided below the right pulley 33b on a rear side of the right extension plate portion 15b. As the drive motor 34, for example, a direct-current motor or a stepping motor can be adopted, and a rotation shaft (output shaft) penetrates the right extension plate portion 15b and extends forward. On the other hand, a rotation shaft of the right pulley 33b also penetrates the right extension plate portion 15b and extends forward. A transmission mechanism 35 including a pulley and a belt is provided between the rotation shaft of the drive motor 34 and the rotation shaft of the right pulley 33b. Therefore, the output (rotation) of the drive motor 34 is transmitted to the right pulley 33b via the transmission mechanism 35 to cause the right pulley 33b to rotate.

The rear second belt 32 is an endless belt having an annular shape and is wound between the left pulley 36a and the right pulley 36b. The left pulley 36a protrudes forward with respect to the left extension plate portion 18a of the second guide holder 12, and a rotation axial center is oriented in the front-rear direction. The right pulley 36b protrudes forward with respect to the right extension plate portion 18b of the second guide holder 12, and a rotation axial center is oriented in the front-rear direction.

The second belt 32 wound between the left pulley 36a and the right pulley 36b includes a belt upper portion 32u that travels in one direction of the left-right direction and a belt lower portion 32d that travels in a direction opposite to the belt upper portion 32u. The second belt 32 is located above the second guide 22, and at least the belt lower portion 32d is parallel to the second guide 22. The right pulley 36b is attached so as to be fixed in a position with respect to the right extension plate portion 18b, while the left pulley 36a is a tension pulley and can change a position in the left-right direction with respect to the left extension plate portion 18a. Accordingly, an appropriate tension can be applied to the second belt 32.

The front right pulley 33b and the rear right pulley 36b are located coaxially, and the axial centers thereof are coupled to each other by a pulley shaft 37 (here, directly coupled without a transmission gear). Therefore, the output (rotation) of the drive motor 34 is also transmitted to the rear right pulley 36b via the transmission mechanism 35 and the pulley shaft 37 to cause the right pulley 36b to rotate. That is, the first belt 31 and the second belt 32 are connected to each other via the right pulley 33b, the pulley shaft 37, and the right pulley 36b, and travel in synchronization (in conjunction) with each other. The front right pulley 33b and the rear right pulley 36b have the same diameter dimension. Therefore, when the drive motor 34 rotates, the first belt 31 and the second belt 32 travel at the same speed.

The left extension plate portion 15a of the first guide holder 11 is provided with a pulley cover 38a that covers the left pulley 33a, and the right extension plate portion 15b is provided with a transmission mechanism cover 38b that covers the pulley and the belt of the transmission mechanism 35. The left extension plate portion 18a of the second guide holder 12 is provided with a pulley cover 38c that covers the left pulley 36a.

### 4. Carriage

The carriage 6 moves in the left-right direction (main scanning direction) along the first guide 21 and the second guide 22 by the first belt 31 and the second belt 32. Next, the configuration of the carriage 6 will be described.

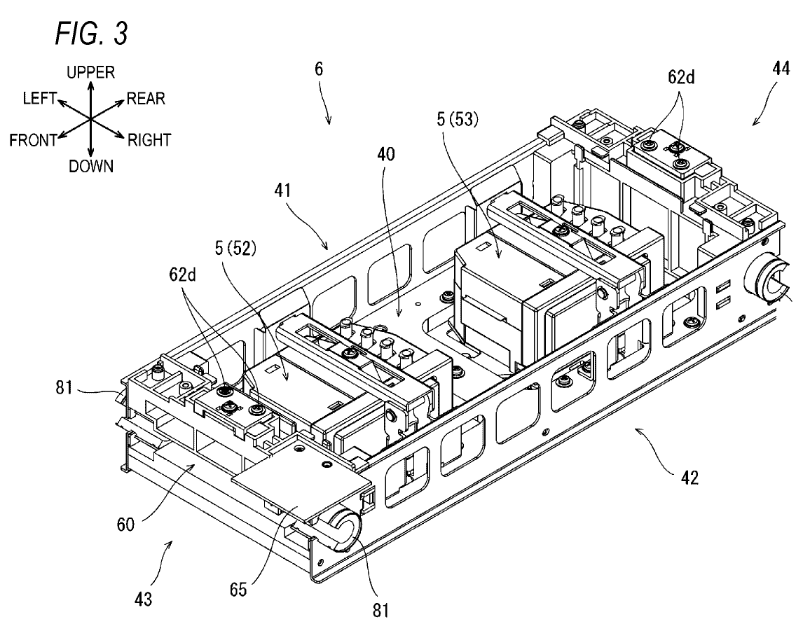

FIG. 3 is a perspective view of the carriage 6 on which two recording heads 5 are mounted. As illustrated in FIG. 3, the carriage 6 has a rectangular shape in which a front-rear dimension is larger than a left-right dimension in a plan view, and has a shallow container shape with a bottom whose upper portion is opened. The carriage 6 is configured by combining a bottom frame 40, a left frame 41, a right frame 42, a front beam 43, and a rear beam 44.

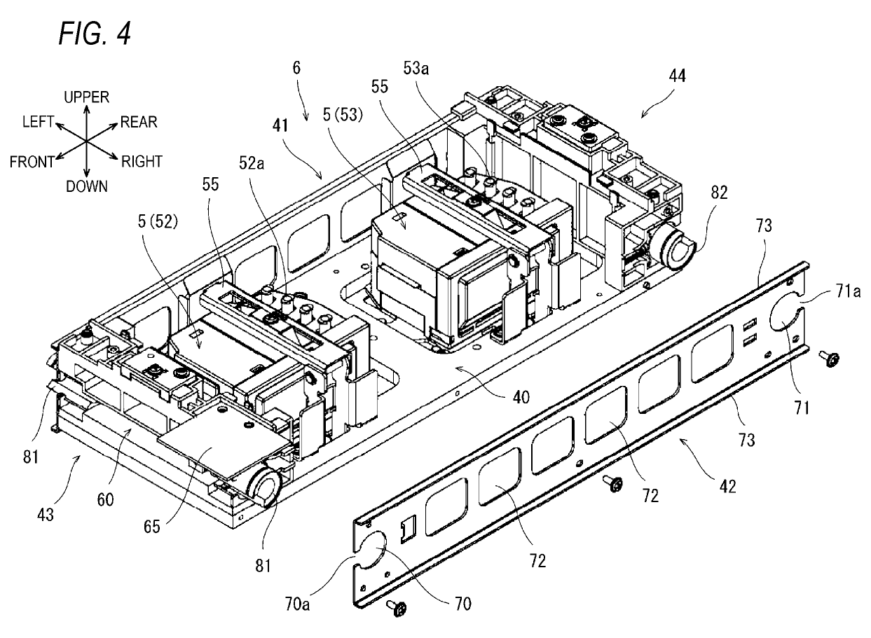

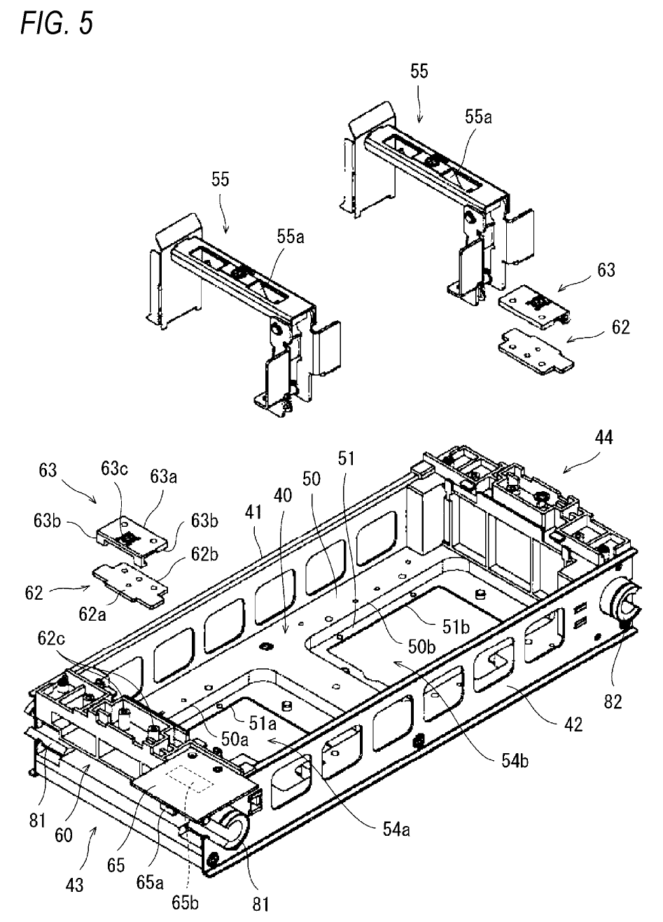

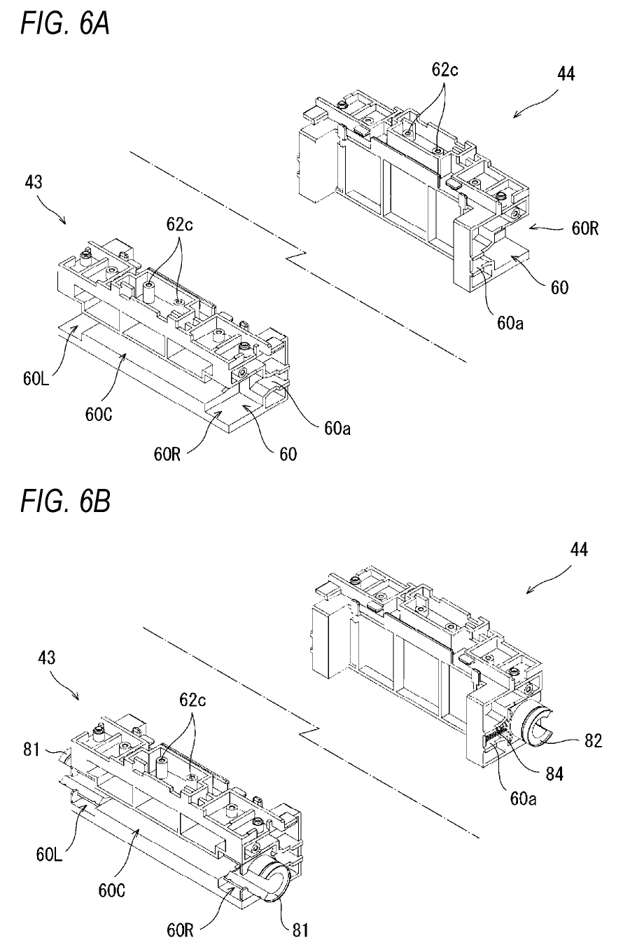

FIGS. 4 to 6 also illustrate the carriage 6. FIG. 4 is a perspective view illustrating the carriage 6 in a state in which the right frame 42 is removed. FIG. 5 is an exploded perspective view illustrating a part of the carriage 6 in a state in which the recording heads 5 are removed. FIG. 6A is a perspective view of the front beam 43 and the rear beam 44, and FIG. 6B is a perspective view illustrating a state in which first intermediate members 81 are partially accommodated in the front beam 43 and a state in which second intermediate members 82 are partially accommodated in the rear beam 44.

### 4.1 Bottom Frame

As illustrated in FIG. 5, the bottom frame 40 has a configuration in which an upper bottom frame 50 and a lower bottom frame 51 are vertically stacked and fixed to each other by fastening units such as screws. The upper bottom frame 50 is constituted by a plate having a rectangular shape long in the front-rear direction, and has two substantially rectangular openings 50a and 50b arranged side by side in the front-rear direction and penetrating in the up-down direction. In addition, the lower bottom frame 51 is constituted by a plate having a rectangular shape long in the front-rear direction, and has two substantially rectangular openings 51a and 51b arranged side by side in the front-rear direction and penetrating in the up-down direction.

The upper bottom frame 50 has a larger thickness dimension and higher rigidity than the lower bottom frame 51. The front opening 50a of the upper bottom frame 50 and the front opening 51a of the lower bottom frame 51 are located at positions corresponding to each other, and the opening 51a is located inside the opening 50a in a plan view. Similarly, the rear opening 50b of the upper bottom frame 50 and the rear opening 51b of the lower bottom frame 51 are located at positions corresponding to each other, and the opening 51b is located inside the opening 50b in a plan view.

The front opening 50a and the front opening 51a constitute an installation space 54a of a color head 52 that ejects color ink in the two recording heads 5, and the rear opening 50b and the rear opening 51b constitute an installation space 54b of the auxiliary liquid head 53 that ejects an auxiliary liquid in the two recording heads 5. Therefore, the color head 52 is located forward of the auxiliary liquid head 53, in other words, the color head 52 is disposed between the auxiliary liquid head 53 and the first guide 21 in the front-rear direction. The auxiliary liquid is either an undercoat liquid serving as an undercoat of the color ink or an overcoat liquid serving as an overcoat of the color ink onto the recording medium M.

### 4.2 Recording Head

The recording head 5 includes, for example, a flow path unit including a plurality of flow paths therein that communicate at a downstream end with a plurality of nozzle holes opened on a nozzle surface, an actuator that applies a discharge pressure to a liquid in each of the flow paths, a sub-tank that communicates with an upstream end of each of the flow paths and stores the liquid, and a supply port of the liquid to the sub-tank. The above configuration of the recording head 5 is an example and is not limited thereto.

In FIG. 4, in the configuration of the recording head 5, supply ports 52a of the color head 52 and supply ports 53a of the auxiliary liquid head 53 are denoted by reference numerals. In this way, the color head 52 includes a plurality of supply ports 52a, and each of the supply ports 52a has a tubular shape facing upward. One end of a flexible tube made of synthetic resin is connected to the supply port 52a, and the other end of the tube is connected to a main tank for the color ink provided at a location other than the carriage 6 in the printer 1.

Similarly, the auxiliary liquid head 53 includes a plurality of supply ports 53a, and each of the supply ports 53a has a tubular shape facing upward. One end of a flexible tube made of synthetic resin is connected to the supply port 53a, and the other end of the tube is connected to a main tank for the auxiliary liquid provided at a location other than the carriage 6 in the printer 1. Therefore, the color ink or the auxiliary liquid is supplied from the main tank to each of the recording heads 5 through the tube.

The recording heads 5 are fixed to the bottom frame 40 by head holders 55 each having a rectangular arch shape. That is, after the recording heads 5 are disposed in the corresponding installation spaces 54a and 54b, the recording heads 5 are sandwiched and fixed in the up-down direction by the head holders 55 fastened to the bottom frame 40 with screws or the like from above. The head holder 55 includes a spring member 55a abutting against an upper surface of the recording head 5, and the recording head 5 is pressed toward the bottom frame 40 with an appropriate pressure by the spring member 55a. In a state in which the recording heads 5 are fixed to the bottom frame 40, the nozzle surfaces of the recording heads 5 are exposed from the openings 51a and 51b.

The recording head 5 may directly supply a liquid from an external main tank to the flow path via the supply port without including the sub-tank. The main tank may be mounted on the carriage 6 together with the recording head 5.

### 4.3 Front Beam and Rear Beam

As illustrated in FIG. 6A, the front beam 43 has a substantially rectangular parallelepiped shape long in the left-right direction, has the same left-right dimension as a left-right dimension of the bottom frame 40, and is attached to an upper surface of a front end of the bottom frame 40 by fastening units such as screws. The front beam 43 is formed with a guide groove 60 that opens forward, is recessed rearward, and extends in the left-right direction. The guide groove 60 is a groove through which the first guide 21 passes, and includes a left groove 60L, a central groove 60C, and a right groove 60R that communicate with each other. The left groove 60L, the central groove 60C, and the right groove 60R are arranged side by side in this order from left to right.

A left end of the left groove 60L opens leftward, and a right end of the right groove 60R opens rightward. The left groove 60L and the central groove 60C are symmetrical and have substantially the same shape and the same dimension. On the other hand, the central groove 60C has a smaller cross-sectional dimension of an internal space than the left groove 60L and the right groove 60R. In such a guide groove 60, each of the left groove 60L and the right groove 60R constitutes an accommodation space in which the first intermediate member 81 fitted onto the first guide 21 is disposed with slack (see FIG. 6B). The first intermediate member 81 is a member that is movable in the left-right direction along the first guide 21 and supports the carriage 6 with respect to the first guide 21, which will be described in detail later.

As illustrated in FIG. 5, a support plate 62 and a clamp 63 for connecting the first belt 31 and the carriage 6 are attached to an upper portion of the front beam 43.

The support plate 62 has a configuration in which a support plate portion 62a having a rectangular shape long in the left-right direction, and an extension plate portion 62b that extends rearward from a trailing end of the support plate portion 62a and whose left-right dimension is smaller than that of the support plate portion 62a are formed by one plate. In the support plate 62, the extension plate portion 62b is fastened to a boss portion 62c protruding from the upper portion of the front beam 43 by screws 62d or the like (see FIG. 3). The belt lower portion 31d of the first belt 31 is placed on an upper surface of the support plate 62.

The clamp 63 includes a cover plate portion 63a having a rectangular shape long in the left-right direction, and leg portions 63b extending downward from four corner portions of the cover plate portion 63a. The clamp 63 is disposed such that the cover plate portion 63a overlaps the support plate portion 62a with the belt lower portion 31d interposed therebetween. At this time, the four leg portions 63b of the clamp 63 extend downward through the belt lower portion 31d and a front side and a rear side of the support plate 62. In addition, among the four leg portions 63b, the two front leg portions 63b have lower ends formed in a claw shape and engaged with the extension plate portion 62b, and the two rear leg portions 63b sandwich the extension plate portion 62b therebetween. Therefore, the clamp 63 is prevented from being displaced in the left-right and front-rear directions with respect to the support plate 62. In this state, the clamp 63 is fastened onto the support plate 62 by a screw 63c or the like, and as a result, the first belt 31 is sandwiched between the support plate 62 and the clamp 63. In this way, the carriage 6 is connected to the first belt 31 (also see FIGS. 1 and 2).

As illustrated in FIG. 6A, the rear beam 44 has a substantially rectangular parallelepiped shape long in the left-right direction, has the same left-right dimension as the left-right dimension of the bottom frame 40, and is attached to an upper surface of a trailing end of the bottom frame 40 by fastening units such as screws. The rear beam 44 has the same configuration as the front beam 43, and includes the guide groove 60. That is, the rear beam 44 causes the front beam 43 to rotate by 180 degrees about an axis in the up-down direction. Therefore, the guide groove 60 of the rear beam 44 has a shape that opens rearward and is recessed forward, and similar to the guide groove 60 of the front beam 44, includes a left groove 60L, a central groove 60C, and a right groove 60R that are arranged side by side in this order from left to right and communicate with each other (left groove 60L and central groove 60C are not illustrated).

In such a guide groove 60 of the rear beam 44, each of the left groove 60L and the right groove 60R constitutes an accommodation space in which the second intermediate member 82 fitted onto the second guide 22 is disposed with slack (see FIG. 6B). The second intermediate member 82 is a member that is movable in the left-right direction along the second guide 22 and supports the carriage 6 with respect to the second guide 22, and will be described in detail later together with the first intermediate member 81.

The support plate 62 and the clamp 63 for connecting the second belt 32 and the carriage 6 are attached to an upper portion of the rear beam 44. The support plate 62 and the clamp 63 have the same configuration as the support plate 62 and the clamp 63 attached to the upper portion of the front beam 43. Therefore, in the same manner as the first belt 31 is fixed to the upper portion of the front beam 43, the belt lower portion 32d of the second belt 32 is fixed to the upper portion of the rear beam 44 by the support plate 62 and the clamp 63. In this way, the carriage 6 is connected to the second belt 32 (also see FIGS. 1 and 2).

As illustrated in FIG. 5, an encoder substrate 65 is attached to the upper portion of the front beam 43 by screws or the like. For example, an optical encoder 65a is mounted on the encoder substrate 65. On the other hand, as illustrated in FIG. 1, a strip 66 extending in the left-right direction along the first guide 21 is provided on an outer surface (front surface) of the front first guide holder 11. The strip 66 is, for example, a band-shaped member long in the left-right direction, and is provided with slits having a predetermined shape at regular intervals. The encoder 65a faces the strip 66, and detects the presence or absence of a slit on the strip 66. A circuit 65b including ASIC or the like is mounted on the encoder substrate 65, and the circuit 65b counts the number of slits detected by the encoder 65a.

Therefore, when the carriage 6 moves, the encoder 65a detects the slits on the strip 66, and the circuit 65b counts the slits detected by the encoder 65a. A position of the carriage 6 in the left-right direction can be detected based on the number of slits counted by the circuit 65b. In this way, the encoder substrate 65 (including the encoder 65a and the circuit 65b) and the strip 66 constitute a position detector that detects the position of the carriage 6 in the left-right direction (main scanning direction) in the printer 1.

### 4.4 Left Frame and Right Frame

As illustrated in FIG. 4, the right frame 42 is constituted by a rectangular plate member that is long in the front-rear direction and has a surface intersecting the left-right direction. A dimension in the front-rear direction (longitudinal direction) of the right frame 42 is the same as a front-rear dimension of the bottom frame 40, and a dimension in the up-down direction (lateral direction) of the right frame 42 is the same as up-down dimensions of the front beam 43 and the rear beam 44.

A front opening portion 70 that opens in the left-right direction (main scanning direction) is formed in a front portion of the right frame 42. The front opening portion 70 has a substantially circular contour shape. A notch 70a that communicates with the front opening portion 70 is formed at a front end of the right frame 42. As will be described later, the first intermediate member 81 is fitted into the front opening portion 70. Similarly, a rear opening portion 71 that opens in the left-right direction (main scanning direction) is formed in a rear portion of the right frame 42. The rear opening portion 71 has an oval contour shape whose front-rear dimension is larger than an up-down dimension. In addition, a notch 71a that communicates with the rear opening portion 71 is formed at a trailing end of the right frame 42. As will be described later, the second intermediate member 82 is fitted into the rear opening portion 71.

The right frame 42 is provided with a plurality of opening portions 72 between the front opening portion 70 and the rear opening portion 71. Further, an upper end edge and a lower end edge of the right frame 42 are provided with right folds 73. The opening portions 72 and the folds 73 reduce a weight and improve a strength of the right frame 42.

The left frame 41 has the same configuration as the right frame 42, and the left frame 41 and the right frame 42 have a bilaterally symmetrical configuration. That is, the left frame 41 includes the front opening portion 70 into which the first intermediate member 81 is fitted, the rear opening portion 71 into which the second intermediate member 82 is fitted, the plurality of opening portions 72 for reducing a weight, and the folds 73 for improving a strength. In addition, similar to the right frame 42, a front end of the left frame 41 communicates with the front opening portion 70 through the notch 70a, and a trailing end of the left frame 41 also communicates with the rear opening portion 71 through the notch 71a.

The left frame 41 and the right frame 42 are connected to the bottom frame 40, the front beam 43, and the rear beam 44. Specifically, the left frame 41 is fastened to a front portion, a central portion, and a rear portion of a left side surface of the upper bottom frame 50 by screws or the like at respective lower portions of a front portion, a central portion, and a rear portion. In addition, the left frame 41 is fastened to an upper portion of a left side surface of the front beam 43 by screws or the like at a front upper portion, and is fastened to an upper portion of a left side surface of the rear beam 44 by screws or the like at a rear upper portion. Similarly, the right frame 42 is fastened to a front portion, a central portion, and a rear portion of a right side surface of the upper bottom frame 50 by screws or the like at respective lower portions of a front portion, a central portion, and a rear portion. In addition, the right frame 42 is fastened to an upper portion of a right side surface of the front beam 43 by screws or the like at a front upper portion, and is fastened to an upper portion of a right side surface of the rear beam 44 by screws or the like at a rear upper portion.

In this way, the bottom frame 40, the left frame 41, the right frame 42, the front beam 43, and the rear beam 44 are firmly connected. In this state, the front opening portion 70 of the left frame 41 communicates with the left groove 60L of the front beam 43, and the rear opening portion 71 communicates with the left groove 60L of the rear beam 44. Similarly, the front opening portion 70 of the right frame 42 communicates with the right groove 60R of the front beam 43, and the rear opening portion 71 communicates with the right groove 60R of the rear beam 44.

### 4.5 First Intermediate Member

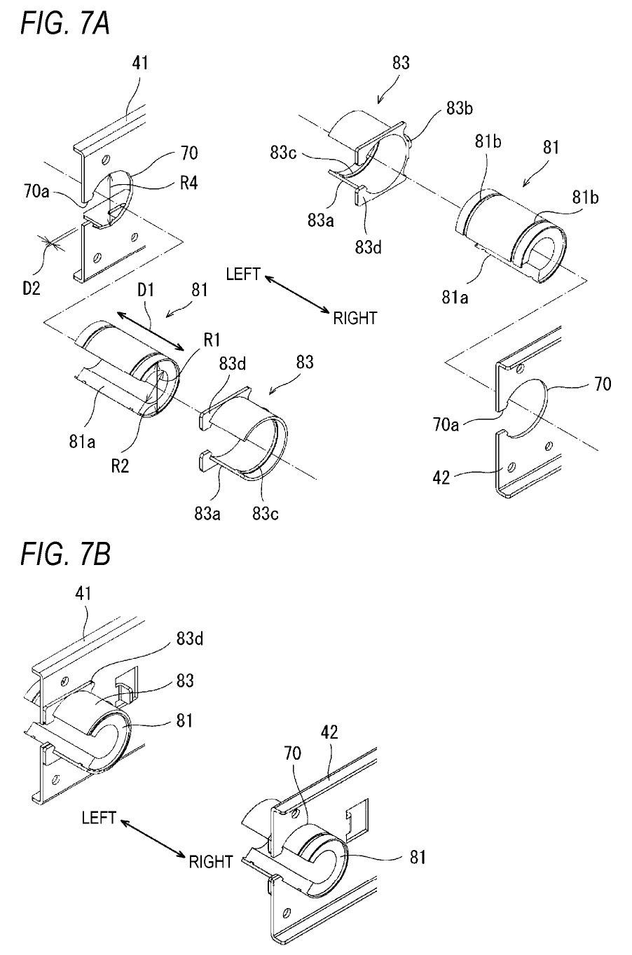

FIG. 7A is a perspective view illustrating the left and right front opening portions 70 and the left and right first intermediate members 81 separated from each other, and FIG. 7B is a perspective view illustrating a state in which the first intermediate members 81 are fitted into the left and right front opening portions 70, respectively. The printer 1 includes two left and right first intermediate members 81 that support the carriage 6 with respect to the first guide 21. The first intermediate members 81 are rotatable about an axial center along at least one direction of the up-down direction (ejection direction) and the front-rear direction (auxiliary operation direction) with respect to the carriage 6.

The first intermediate member 81 is a member including a slit-shaped notch 81a extending from one opening end to the other opening end in a part of a columnar member in a circumferential direction, and having a cross section intersecting an axial center direction in a shape like an alphabet C. The first intermediate member 81 has a substantially perfect circular shape in which a contour shape of an inner periphery and a contour shape of an outer periphery in the cross section are coaxial, and has an inner diameter (diameter) dimension R1 and an outer diameter (diameter) dimension R2. The inner diameter dimension R1 is substantially the same as or slightly larger than an outer diameter (diameter) dimension R3 (see FIG. 2) of the first guide 21, and the outer diameter dimension R2 is substantially the same as or slightly smaller than an inner diameter (diameter) dimension R4 of the front opening portion 70.

A dimension D1 of the first intermediate member 81 in the left-right direction, which is the axial center direction, is larger than a dimension D2 of the front opening portion 70 in the left-right direction. In the present embodiment, the dimension D2 of the front opening portion 70 in the left-right direction is the same as left-right thickness dimensions of the left frame 41 and the right frame 42. In addition, a circumferential groove 81b extending along the circumferential direction is formed on an outer peripheral surface of the first intermediate member 81 in the vicinity of left and right end portions.

As illustrated in FIG. 5, the first intermediate member 81 is disposed on a front side of the carriage 6, and is interposed between the carriage 6 and the first guide 21. That is, the right first intermediate member 81 is provided such that a right end portion is fitted into the front opening portion 70 of the right frame 42 (see a right diagram in FIG. 7B), and the remaining left side portion is accommodated in the right groove 60R of the front beam 43 (see a left diagram in FIG. 6B). A left-right dimension of the right groove 60R is smaller than a left-right dimension of the first intermediate member 81. Therefore, the right end portion of the first intermediate member 81 accommodated in the right groove 60R is exposed from the right groove 60R, and the right end portion is fitted into the front opening portion 70.

As illustrated in FIGS. 7A and 7B, a retaining stopper 83 is fitted onto the first intermediate member 81. The stopper 83 has a cylindrical shape in which a part in the circumferential direction is opened by the notch 83a, and has an inner diameter dimension that is substantially the same as the outer diameter dimension R2 of the first intermediate member 81. The stopper 83 includes an engaging protrusion 83b protruding outward from an outer peripheral surface on a side opposite to the notch 83a with respect to the axial center. A circumferential rib 83c protruding inward and extending in the circumferential direction is provided on an inner circumferential surface of the stopper 83, and a flange 83d extending in a diameter expansion direction is provided at one end portion of the stopper 83.

The stopper 83 is fitted onto the right first intermediate member 81 in a state in which the flange 83d faces rightward, and is positioned such that the left circumferential groove 81b and the circumferential rib 83c are engaged with each other. In addition, as illustrated in FIG. 6A, engaging recesses 60a recessed rearward are formed in rear portions (deep portions) of inner surfaces of the right groove 60R and the left groove 60L of the front beam 43. The engaging protrusion 83b of the stopper 83 is fitted into the engaging recess 60a. In the front beam 43, a right side of the engaging recess 60a is opened, and the opened portion is covered with the right frame 42.

In this way, the right first intermediate member 81 is accommodated in the right groove 60R and is fitted into the front opening portion 70 of the right frame 42. In this state, the leftward movement of the first intermediate member 81 is restricted by the contact between a left end portion of the first intermediate member 81 and a stepped portion of the right groove 60R and the central groove 60C. The rightward movement of the first intermediate member 81 is restricted by the contact between the flange 83d of the stopper 83 and the right frame 42.

On the other hand, there is a gap between the first intermediate member 81 and an inner surface of the right groove 60R, and in this state, the first intermediate member 81 is fitted into the front opening portion 70. Therefore, the first intermediate member 81 is rotatable (or displaceable) about each axial center along the up-down direction and the front-rear direction. As described above, the dimension D2 of the front opening portion 70 in the left-right direction is smaller than the dimension D1 of the first intermediate member 81 in the left-right direction, and thus a contact area between the first intermediate member 81 and the front opening portion 70 is reduced, and the first intermediate member 81 is likely to be rotated.

The first guide 21 is inserted into the first intermediate member 81, and the first intermediate member 81 moves in the left-right direction along the first guide 21 together with the carriage 6. At this time, the notch 81a of the first intermediate member 81, the notch 83a of the stopper 83, and the notch 70a of the front opening portion 70 of the right frame 42 constitute a space through which the leading end portions 23b of the plurality of support protrusions 23 supporting the first guide 21 pass.

Similar to the right first intermediate member 81, the left first intermediate member 81 supports the carriage 6 with respect to the first guide 21. That is, as can be seen from FIGS. 7A and 7B, a support mode of the carriage 6 by the left first intermediate member 81 and a support mode of the carriage 6 by the right first intermediate member 81 are only reversed in configuration, arrangement, and posture. Therefore, the detailed description of the support mode of the carriage 6 by the left first intermediate member 81 will be omitted. The left first intermediate member 81 is also fitted into the front opening portion 70 of the left frame 41 so as to be rotatable about each axial center along the up-down direction and the front-rear direction.

A magnitude relation between curvatures may be established such that the curvature of a contact location of the first intermediate member 81 with the front opening portion 70 is larger than the curvature of a contact location of the front opening portion 70 with the first intermediate member 81. In this case, a contact area between the first intermediate member 81 and the front opening portion 70 can be reduced, and the first intermediate member 81 is likely to be displaced (rotated). Examples of the configuration in which such a magnitude relation between the curvatures is established include a configuration in which the outer diameter dimension R2 of the first intermediate member 81 is smaller than the inner diameter dimension R4 of the front opening portion 70 as described above, and a configuration in which the front opening portion 70 has an elliptical or oval contour shape.

As described above, the first intermediate members 81 are provided at a plurality of locations (here, two locations) of the carriage 6. Accordingly, the carriage 6 is supported at a plurality of locations with respect to the first guide 21, and thus a movement posture of the carriage 6 is stabilized, and the carriage 6 can move smoothly. In the present embodiment, the configuration in which the two left and right first intermediate members 81 are provided in a front portion of the carriage 6 is exemplified, but the present invention is not limited thereto. One or more first intermediate members 81 may be provided between the left and right first intermediate members 81. Alternatively, if the movement of the carriage 6 can be stabilized and made smooth, only one first intermediate member 81 may be provided.

### 4.6 Second Intermediate Member

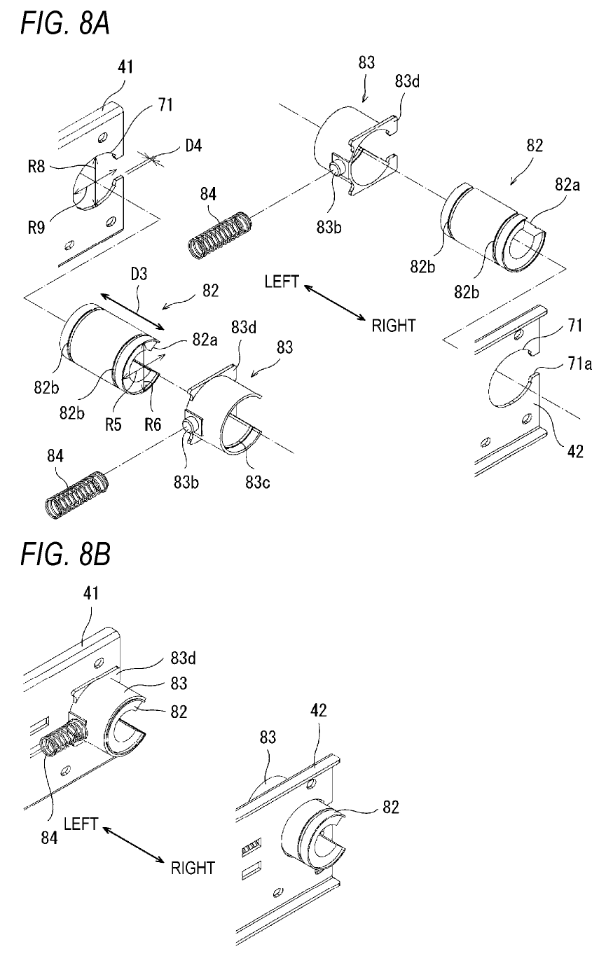

FIG. 8A is a perspective view illustrating the left and right rear opening portions 71 and the left and right second intermediate members 82 separated from each other, and FIG. 8B is a perspective view illustrating a state in which the second intermediate members 82 are fitted into the left and right rear opening portions 71, respectively. Both the left and right second intermediate members 82 have the same configuration as the first intermediate members 81. That is, the second intermediate member 82 has a cylindrical shape having an inner diameter dimension R5, an outer diameter dimension R6, and a left-right dimension D3, and has a slit-shaped notch 82a and two circumferential grooves 82b. The inner diameter dimension R5 is substantially the same as or slightly larger than an outer diameter dimension R7 (see FIG. 2) of the second guide 22. On the other hand, the outer diameter dimension R6 is substantially the same as or slightly smaller than a short diameter dimension R8, which is an up-down dimension of the rear opening portion 71 having an oval shape as described above, and is smaller than a long diameter dimension R9 (> R8), which is the front-rear dimension of the rear opening portion 71.

The dimension D3 of the second intermediate member 82 in the left-right direction, which is the axial center direction, is larger than a dimension D4 of the rear opening portion 71 in the left-right direction. In the present embodiment, the left-right dimension D4 of the rear opening portion 71 is the same as the left-right thickness dimensions of the left frame 41 and the right frame 42, and is the same as the left-right dimension D2 of the front opening portion 70.

As illustrated in FIG. 5, the second intermediate member 82 is disposed on a rear side of the carriage 6, and is interposed between the carriage 6 and the second guide 22. That is, the right second intermediate member 82 is provided such that a right end portion is fitted into the rear opening portion 71 of the right frame 42 (see a right diagram in FIG. 8B), and the remaining left side portion is accommodated in the right groove 60R of the rear beam 44 (see a right diagram in FIG. 6B). Here, the left-right dimension of the right groove 60R is smaller than the left-right dimension of the second intermediate member 82. Therefore, the right end portion of the second intermediate member 82 accommodated in the right groove 60R is exposed from the right groove 60R, and the right end portion is fitted into the rear opening portion 71.

As illustrated in FIGS. 8A and 8B, the retaining stopper 83 is also fitted onto the second intermediate member 82. The stopper 83 is fitted onto the right second intermediate member 82 in a state in which the flange 83d faces rightward, and is positioned such that the left circumferential groove 82b and the circumferential rib 83c are engaged with each other. In addition, as illustrated in FIG. 6A, the engaging recesses 60a recessed forward are formed in front portions (deep portions) of inner surfaces of the right groove 60R and the left groove 60L of the rear beam 44. On the other hand, one end (trailing end) of a biasing member 84 constituted by a coil spring is fitted onto the engaging protrusion 83b of the stopper 83. Then, as illustrated in the right diagram in FIG. 6B, the engaging protrusion 83b and the biasing member 84 are fitted into the engaging recess 60a. The other end (front end) of the biasing member 84 abuts against a deep portion of the engaging recess 60a and is compressed in the front-rear direction, and biases the stopper 83 rearward away from the engaging recess 60a. In the rear beam 44, the right side of the engaging recess 60a is opened, and the opened portion is covered with the right frame 42.

In this way, the right second intermediate member 82 is accommodated in the right groove 60R of the rear beam 44 and is fitted into the rear opening portion 71 of the right frame 42. In this state, the leftward movement of the second intermediate member 82 is restricted by the contact between a left end portion of the second intermediate member 82 and a stepped portion of the right groove 60R and the central groove 60C. The rightward movement of the second intermediate member 82 is restricted by the contact between the flange 83d of the stopper 83 and the right frame 42.

On the other hand, there is a gap between the second intermediate member 82 and the inner surface of the right groove 60R, and in this state, the second intermediate member 82 is fitted into the rear opening portion 71. Therefore, the second intermediate member 82 is rotatable (or displaceable) about each axial center along the up-down direction and the front-rear direction. As described above, the left-right dimension D4 of the rear opening portion 71 is smaller than the left-right dimension D3 of the second intermediate member 82, and thus a contact area between the second intermediate member 82 and the rear opening portion 71 is reduced, and the second intermediate member 82 is likely to be rotated.

The second guide 22 is inserted into the second intermediate member 82, and the second intermediate member 82 moves in the left-right direction along the second guide 22 together with the carriage 6. At this time, the notch 82a of the second intermediate member 82, the notch 83a of the stopper 83, and the notch 71a of the rear opening portion 71 of the right frame 42 constitute a space through which the leading end portions 24b of the plurality of support protrusions 24 supporting the second guide 22 pass.

Similar to the right second intermediate member 82, the left second intermediate member 82 supports the carriage 6 with respect to the second guide 22. That is, as can be seen from FIGS. 8A and 8B, a support mode of the carriage 6 by the left second intermediate member 82 and a support mode of the carriage 6 by the right second intermediate member 82 are only reversed in configuration, arrangement, and posture. Therefore, the detailed description of the support mode of the carriage 6 by the left second intermediate member 82 will be omitted. The left second intermediate member 82 is also fitted into the rear opening portion 71 of the left frame 41 so as to be rotatable about each axial center along the up-down direction and the front-rear direction. In addition, the second intermediate member 82 is biased rearward together with the stopper 83 by the biasing member 84.

A magnitude relation between curvatures may be established such that the curvature of a contact location of the second intermediate member 82 with the rear opening portion 71 is larger than the curvature of a contact location of the rear opening portion 71 with the second intermediate member 82. In this case, the contact area between the second intermediate member 82 and the rear opening portion 71 can be reduced, and the second intermediate member 82 is likely to be displaced (rotated). In the configuration of the present embodiment in which an outer shape of the second intermediate member 82 is a perfect circle, and a contour of the rear opening portion 71 is an oval as described above, the magnitude relation of the curvatures is established.

As described above, the second intermediate members 82 are provided at a plurality of locations (here, two locations) of the carriage 6. Accordingly, the carriage 6 is supported at a plurality of locations with respect to the second guide 22, and thus a movement posture of the carriage 6 is stabilized, and the carriage 6 can move smoothly. In the present embodiment, the configuration in which the two left and right second intermediate members 82 are provided in a rear portion of the carriage 6 is exemplified, but the present invention is not limited thereto. One or more second intermediate members 82 may be provided between the left and right second intermediate members 82. Alternatively, if the movement of the carriage 6 can be stabilized and made smooth, only one second intermediate member 82 may be provided.

In the rear portion of the carriage 6, the biasing member 84 is provided between the stopper 3 and the rear beam 44. The biasing member 84 biases the second intermediate member 82 rearward and, at the same time, biases the carriage 6 forward as a reaction thereto. That is, the biasing member 84 biases the first intermediate member 81 toward the first guide 21. Accordingly, the first intermediate member 81 easily follows the first guide 21 during the movement of the carriage 6, and the first intermediate member 81 can be prevented from being stacked on the first guide 21. As described above, the biasing member 84 biases the second intermediate member 82 rearward, that is, toward the second guide 22. Therefore, the second intermediate member 82 easily follows the second guide 22 during the movement of the carriage 6, and the second intermediate member 82 can be prevented from being stacked on the second guide 22.

### 5. Operations and Effects

As described above, the printer 1 includes the first intermediate member 81 that supports the carriage 6 with respect to the first guide 21 and is rotatable about the axial center along at least one direction of the up-down direction and the front-rear direction. Accordingly, even if the first guide 21 is deformed, for example, bent due to use over time, the first intermediate member 81 rotates following the deformation, but the rotation of the first intermediate member 81 is less likely to be transmitted to the carriage 6.

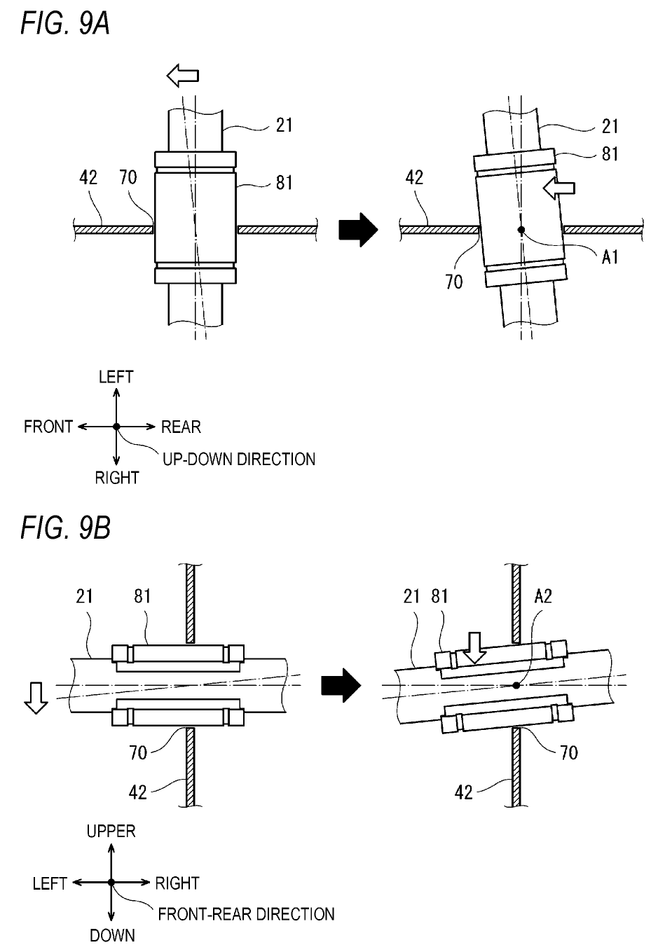

FIG. 9A is a schematic diagram of the periphery of the first intermediate member 81 when viewed along the up-down direction. As illustrated in a left diagram in FIG. 9A, when the first guide 21 is bent in the front-rear direction, the first intermediate member 81 fitted into the front opening portion 70 can rotate about an axial center A1 in the up-down direction and follow the first guide 21 as illustrated in a right diagram in FIG. 9A. In addition, there is a slight gap between the first intermediate member 81 and the front opening portion 70, and thus the rotation of the carriage 6 is prevented during the rotation of the first intermediate member 81. Although there is a gap between the first intermediate member 81 and the front opening portion 70, but the first intermediate member 81 and the front opening portion 70 are firmly abutted against each other by a biasing force of the biasing member 84, and thus no wobbling occurs.

FIG. 9B is a schematic diagram of the periphery of the first intermediate member 81 when viewed along the front-rear direction. As illustrated in a left diagram in FIG. 9B, when the first guide 21 is bent in the up-down direction, the first intermediate member 81 fitted into the front opening portion 70 can rotate about an axial center A2 in the front-rear direction and follow the first guide 21 as illustrated in a right diagram in FIG. 9B. In addition, there is a slight gap between the first intermediate member 81 and the front opening portion 70, and thus the rotation of the carriage 6 is prevented during the rotation of the first intermediate member 81.

In this way, according to the printer 1 of the present embodiment, the movement posture of the carriage 6 is stabilized, or the stack during the movement of the carriage 6 can be prevented to make the movement smooth. As a result, the quality of a printed image can be improved. In the case of the printer 1 of the present embodiment, the second intermediate member 82 is also rotatable about an axial center along at least one direction of the up-down direction and the front-rear direction with respect to the rear opening portion 71. Therefore, the movement posture of the carriage 6 can be stabilized against the bending of the second guide 22, or the stack during the movement of the carriage 6 can be prevented to make the movement smooth.

A relation between the dimension D1 of the first intermediate member 81 and the dimension D2 of the front opening portion 70 is not particularly limited, but when D1 > D2 as in the present embodiment, the first intermediate member 81 is likely to be displaced (rotated) in a state of being fitted into the front opening portion 70. Accordingly, the first intermediate member 81 can favorably follow the bending of the first guide 21, and the movement posture of the carriage 6 is stabilized. Similarly, a relation between the dimension D3 of the second intermediate member 82 and the dimension D4 of the rear opening portion 71 is not particularly limited, but when D3 > D4 as in the present embodiment, the second intermediate member 82 is likely to be displaced (rotated) in a state of being fitted into the rear opening portion 71. Accordingly, the second intermediate member 82 can favorably follow the bending of the second guide 22, and the movement posture of the carriage 6 is stabilized.

The curvature of the contact location of the first intermediate member 81 with the front opening portion 70 may be larger than the curvature of the contact location of the front opening portion 70 with the first intermediate member 81. Due to such a magnitude relation between the curvatures, the contact area therebetween is reduced, and the first intermediate member 81 is likely to be displaced (rotated). Similarly, the curvature of the contact location of the second intermediate member 82 with the rear opening portion 71 may be larger than the curvature of the contact location of the rear opening portion 71 with the second intermediate member 82, and in this case, the contact area therebetween is reduced, and the second intermediate member 82 is likely to be displaced (rotated).

The first intermediate member 81 is biased toward the first guide 21 by the biasing member 84. In this way, the first intermediate member 81 easily follows the first guide 21 during the movement of the carriage 6, and the first intermediate member 81 can be prevented from being stacked on the first guide 21. In addition, it is possible to prevent rattling during the movement of the carriage 6. Similarly, the second intermediate member 82 is biased toward the second guide 22 by the biasing member 84, and thus the stack of the second intermediate member 82 and the rattling during the movement of the carriage 6 can be prevented. An attachment position of the biasing member 84 is not limited to the engaging protrusion 83b of the stopper 83 for the second intermediate member 82. The attachment position may be other positions as long as at least one of biasing the first intermediate member 81 toward the first guide 21 and biasing the second intermediate member 82 toward the second guide 22 can be implemented, and other configurations may be adopted. The biasing member 84 is not essential in the printer 1, and may be omitted.

The carriage 6 is provided with the first intermediate members 81 at a plurality of locations. In this case, the carriage 6 can be supported at a plurality of different locations with respect to the first guide 21, and thus the posture of the carriage 6 can be stabilized. Similarly, the carriage 6 is provided with the second intermediate members 82 at a plurality of locations, and thus the carriage 6 can be supported at a plurality of different locations with respect to the second guide 22, and the posture of the carriage 6 can be stabilized. The printer 1 may include only one first intermediate member 81 or only one second intermediate member 82.

In the present embodiment, the configuration in which the same number of the first intermediate members 81 and the second intermediate members 82 are provided has been exemplified, but the present invention is not limited thereto. For example, the number of second intermediate members 82 may be equal to or smaller than the number of first intermediate members 81. Here, if there are many first intermediate member 81 and second intermediate member 82, the posture of the carriage 6 can be stabilized, but the cost also increases. On the other hand, as described above, in the printer 1, a member having higher straightness than the second guide 22 is adopted as the first guide 21 when there is a difference in the straightness, and thus the posture of the carriage 6 can be stabilized even if the number of the second intermediate members 82 is smaller than that of the first intermediate members 81. Therefore, the posture of the carriage 6 can be stabilized while preventing the increase in cost.

When the carriage 6 can be stably moved, the second guide 22 and the second intermediate member 82 may be omitted. In this case, for example, the first guide 21 may be disposed in the vicinity of a center of the head conveying device 3 in the front-rear direction (for example, between the color head 52 and the auxiliary liquid head 53), and the first intermediate member 81 may be interposed between the first guide 21 and the carriage 6. On the other hand, as in the present embodiment, when the second guide 22 that guides the movement of the carriage 6 in the left-right direction is further provided in addition to the first guide 21, the movement posture of the carriage 6 is further stabilized. Furthermore, as in the present embodiment, by providing the first guide 21 and the second guide 22 arranged in the front and rear, and the first intermediate member 81 and the second intermediate member 82, the movement posture of the carriage 6 can be further stabilized. In the present embodiment, the configuration in which the first guide 21 and the second guide 22 are disposed at the same height is exemplified, but the present invention is not limited thereto. A configuration in which the first guide 21 and the second guide 22 are disposed at different heights may be adopted.

The printer 1 causes the carriage 6 to move by the first belt 31 and the second belt 32 arranged in the front and rear. In this case, the carriage 6 long in the front-rear direction can be stably supported by the two belts, and the movement posture can be stabilized. As long as a desired movement posture can be stabilized, the carriage 6 may be moved by one belt, or using three or more belts.

The first belt 31 is located closer to the first guide 21 than the second belt 32, and the drive motor 34 is disposed closer to the first belt 31 than the second belt 32. In this case, a power transmission distance from the rotation shaft of the drive motor 34 to the right pulley 33b of the first belt 31 is shorter than a power transmission distance from the rotation shaft of the drive motor 34 to the right pulley 36b of the second belt 32 by the pulley shaft 37. Therefore, the first belt 31 has excellent responsiveness to an operation of the drive motor 34.

The printer 1 is provided with the position detector including the encoder substrate 65 and the strip 66 near the first belt 31 having good responsiveness, and thus the position of the carriage 6 can be controlled with high accuracy. In the carriage 6, the color head 52 is disposed between the auxiliary liquid head 53 and the first guide 21 in the front-rear direction. That is, the color head 52 is disposed on a front side on which the first belt 31 having good responsiveness is located. Accordingly, the color ink can be landed on the recording medium M with high positional accuracy. However, the arrangement of the first belt 31 is not limited to the aspect described above.

The directions of the rotatable axial centers of the intermediate members 81 and 82 that support the carriage 6 may all be the same or may be different from each other.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

### INDUSTRIAL APPLICABILITY

The present disclosure can be applied to the inkjet printer including the carriage that moves in the main scanning direction.

What is claimed is:

1. An inkjet printer comprising:
a first guide extending in a main scanning direction;
a carriage on which a recording head configured to eject a liquid in an ejection direction intersecting the main scanning direction configured to be mounted, the carriage being configured to move along the first guide; and
a first intermediate member configured to:
support the carriage with respect to the first guide; and
being rotatable about an axial center along at least one direction of
the ejection direction, and
a sub-scanning direction intersecting the main scanning direction and the ejection direction with respect to the carriage.

2. The inkjet printer according to claim 1, wherein
the carriage includes an opening portion configured to open in the main scanning direction,
the first intermediate member is fitted into the opening portion, and
a dimension of the opening portion in the main scanning direction is smaller than a dimension of the first intermediate member in the main scanning direction.

3. The inkjet printer according to claim 1, wherein
the carriage includes an opening portion configured to open in the main scanning direction,
the first intermediate member is fitted into the opening portion, and
a curvature of a contact location of the first intermediate member with the opening portion is larger than a curvature of a contact location of the opening portion with the first intermediate member.

4. The inkjet printer according to claim 1, further comprising:
a biasing member configured to bias the first intermediate member toward the first guide.

5. The inkjet printer according to claim 1, wherein
the first intermediate member is provided at a plurality of locations of the carriage.

6. The inkjet printer according to claim 1, further comprising:
a second guide extending in the main scanning direction and separate from the first guide, wherein
the carriage is guided by the first guide and the second guide and moves in the main scanning direction.

7. The inkjet printer according to claim 6, further comprising:
a second intermediate member configured to:
support the carriage with respect to the second guide; and
being rotatable about an axial center along at least one direction of
the main scanning direction, the ejection direction, and the sub-scanning direction with respect to the carriage.

8. The inkjet printer according to claim 7, wherein
the number of second intermediate members is equal to or smaller than the number of first intermediate members.

9. The inkjet printer according to claim 1, wherein
the recording head includes a color head configured to eject color ink, and an auxiliary liquid head configured to eject an auxiliary liquid, which is either an undercoat liquid serving as an undercoat of the color ink or an overcoat liquid serving as an overcoat of the color ink, onto a recording medium, and
the color head and the auxiliary liquid head are arranged side by side in the sub-scanning direction, and the color head is disposed between the auxiliary liquid head and the first guide in the sub-scanning direction.

10. The inkjet printer according to claim 1, wherein
the carriage moves in the main scanning direction by a first belt and a second belt that are connected to each other via a drive pulley and are arranged apart from each other in the sub-scanning direction.

11. The inkjet printer according to claim 10, wherein
the first belt is located closer to the first guide than the second belt, and a drive motor configured to rotate the drive pulley is disposed closer to the first belt than the second belt.
